(19) United States
(12) Patent Application Publication
(10) Pub. No.: US 2021/0380170 A1
(43) Pub. Date: Dec. 9, 2021

(54) FRAME FOR AN OFF-ROAD VEHICLE

(71) Applicant: Polaris Industries Inc., Medina, MN (US)

(72) Inventors: Robert C. Wilmot, Stacy, MN (US); Anthony J. Ripley, Ham Lake, MN (US)

(73) Assignee: Polaris Industries Inc., Medina, MN (US)

(21) Appl. No.: 17/337,693

(22) Filed: Jun. 3, 2021

Related U.S. Application Data
(60) Provisional application No. 63/035,164, filed on Jun. 5, 2020.

(51) Int. Cl. B62D 21/11; B60N 3/10; B60K 17/34; B60N 2/005; B60H 1/00

(52) U.S. Cl. CPC B62D 21/11; B60N 3/104; B60H 1/00514; B60N 2/005; B60K 17/34

(57) ABSTRACT

A vehicle shown herein is a side by side utility vehicle having a frame, front and rear ground engaging members supporting the frame, a powertrain drivingly coupled to the front and rear ground engaging members, and a seating area supported by the frame. The frame can include a tunnel extending longitudinally through at least a portion of the seating area, and the tunnel supports one or more HVAC components.

### CROSS-REFERENCE TO RELATED APPLICATION

This application claims the benefit of U.S. Provisional Patent Application No. 63/035,164, filed Jun. 5, 2020 and entitled FRAME FOR AN OFF-ROAD VEHICLE, the entire disclosure of which is incorporated herein by reference.

### FIELD OF THE DISCLOSURE

The present invention relates to off-road vehicles (e.g., utility vehicles (“UTVs”) or all-terrain vehicles (“ATVs”)) and, more particularly, to a frame for an off-road vehicle.

### BACKGROUND OF THE DISCLOSURE

Generally, UTVs or ATVs include frames that are surrounded by body panels. Many times these body panels do not fully enclose the occupants of the UTV, and therefore, the occupants are exposed to the elements (cold, rain, mud, etc.). Additionally, the frame of such vehicles may be designed as a single structure that is purpose built for a single application of a UTV. Therefore, a need exists for an enclosed UTV or ATV design that can be adapted to different vehicle applications.

Additionally, in the case where the occupants of the vehicles are enclosed, the enclosure can be either too hot (e.g., in the summer) or too cold (e.g., in the winter) for the occupants of the vehicle. Therefore, a need exists to supply HVAC components to the vehicle.

### SUMMARY OF THE DISCLOSURE

In one embodiment of the disclosure, a vehicle comprises a frame, front and rear ground engaging members supporting the frame, a powertrain drivingly coupled to the front and rear ground engaging members, and a seating area supported by the frame wherein the frame comprises a tunnel extending longitudinally through at least a portion of the seating area, and the tunnel supports one or more HVAC components.

In another embodiment of the disclosure, a casting for a vehicle comprises a main body configured to support at least two of forward mounting members, steering mounts, suspension mounts, and front drive mounts.

### BRIEF DESCRIPTION OF THE DRAWINGS

FIG. 1 shows a front left perspective view of a vehicle of the present disclosure;

FIG. 2 shows a right rear perspective view of the vehicle of FIG. 1;

FIG. 3 shows a left elevational side view of the vehicle of FIG. 1;

FIG. 4 shows a right elevational side view of the vehicle of FIG. 1;

FIG. 5 shows a top plan view of the vehicle of FIG. 1;

FIG. 6 shows a front elevational view of the vehicle of FIG. 1;

FIG. 7 shows a rear elevational view of the vehicle of FIG. 1;

FIG. 8 shows a front left perspective view of a tunnel area of the vehicle of FIG. 1;

FIG. 9 shows a front left perspective view of a tunnel substructure of the tunnel area of FIG. 8;

FIG. 10 shows an enlarged front perspective view of a cutout of the tunnel area of the vehicle of FIG. 8.

FIG. 11 is an enlarged left elevation side view of a cutout of the tunnel area of the vehicle of FIG. 8;

FIG. 12 shows a front left perspective view of a front clip of the vehicle of FIG. 1;

FIG. 13 shows an exploded view of a frame assembly of the vehicle of FIG. 1; and

FIG. 14 shows a left side exploded view of the frame assembly of FIG. 13.

### DETAILED DESCRIPTION OF THE DRAWINGS

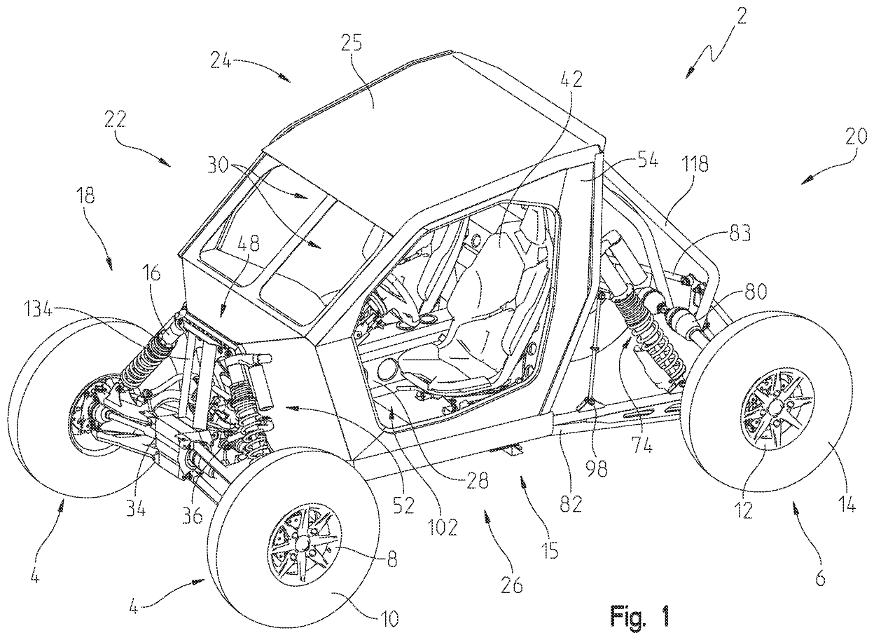

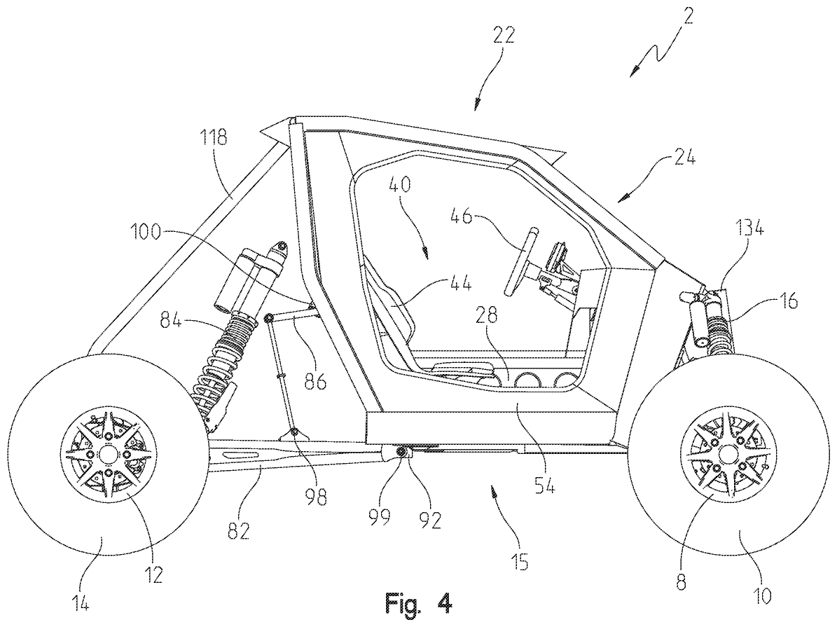

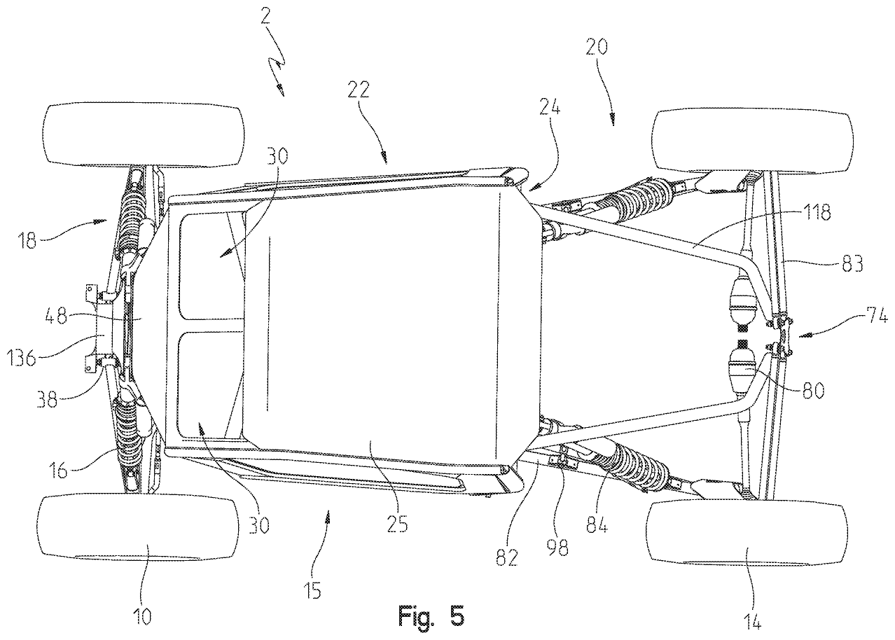

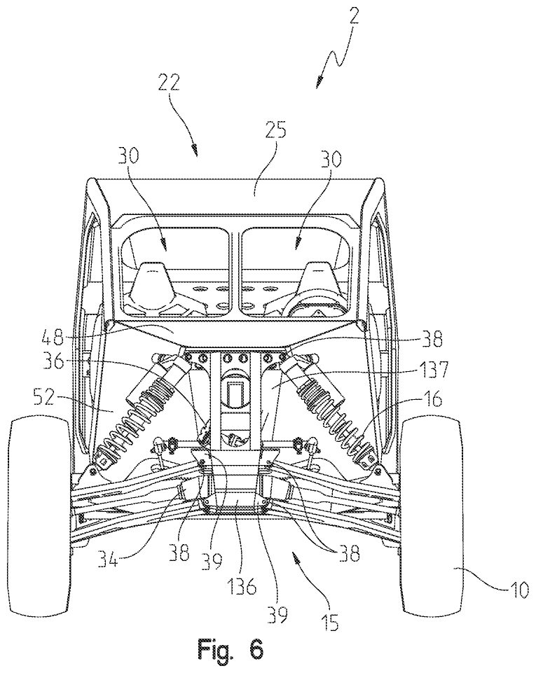

With reference first to FIGS. 1-8, the vehicle of the present disclosure is described. As shown, the vehicle is generally depicted as reference number 2 which includes front ground engaging members 4 and rear ground engaging members 6. Illustratively, front ground engaging members 4 are comprised of rims 8 and tires 10, and rear ground engaging members 6 are comprised of rims 12 and tires 14. Front ground engaging members 4 support vehicle 2 through front suspension assembly 16. Rear ground engaging members 6 support vehicle 2 through rear suspension assembly 74. Front and rear suspension assemblies 16 and 74 are operably coupled to a frame assembly 15 of vehicle 2. Frame assembly 15 may be comprised of a front clip 18, generally defining a front portion of frame assembly 15, and a rear subframe 20, generally defining a rear portion of frame assembly 15. As disclosed further herein, at least portions of frame assembly 15 may include various panels, generally defining body panels, such that frame assembly 15 at least partially defines a monocoque.

Frame assembly 15 of vehicle 2 includes or at least partially defines operator area or cockpit 22 positioned generally longitudinally between front clip 18 and rear subframe 20. As discussed in additional detail herein, cockpit 22 is removably or integrally connected to front clip 18, rear subframe 20, and rear suspension assembly 74 at multiple coupling points by connection joints such that cockpit 22 is bolted, bonded, welded, and/or keyed to front clip 18, rear subframe 20, and rear suspension assembly 74 to form vehicle 2. The use of the coupling points as connections to cockpit 22 allows for a variety of designs of front clips 18 and/or rear subframes 20 to be attached to cockpit 22 such that cockpit 22 provides the base structure for many types of UTVs. In this way, frame assembly 15 may be a modular frame assembly, easily adaptable to various vehicle designs and applications. In some embodiments, cockpit 22 can be a monocoque where portions of frame assembly 15 and the body (e.g., the enclosure) are integrally formed as a single structure. In other embodiments, parts of cockpit 22 (e.g., the roof or the base) can be a monocoque design, which can be attached together to form cockpit 22.

Cockpit 22 includes upper frame 24, seating frame 102, and lower cockpit frame 26. Seating frame 102 supports seating area 40 including driver's seat 42 and passenger seat 44. Seating frame 102 can be attached to, or part of, lower cockpit frame 26. Cockpit 22 supports a portion of steering assembly 36 and, more particularly, includes a tiltable and longitudinally moveable steering wheel 46.

Cockpit 22 may include various panels to enclose at least a portion of seating area 40. In one embodiment, cockpit 22 includes integral panels such to define a monocoque, while in other embodiments, such panels may be defined as separate body panels coupled to portions of frame assembly 15. Cockpit 22 may include upper frame 24 defined by a roof panel 25, side panels 54, front panel 52, hood panel 48, and rear panel 56, each of which can be attached together and/or to various portions of frame assembly 15 at any number of load points by connection joints (e.g., via bolts, couplers, welds, rivets, etc.) to form cockpit 22. The various panels 25, 48, 52, 54, 56 of cockpit 22 can be formed through bending, stamping, and/or forming processes and may be comprised of sheets or other configurations of metal, plastic, composite materials, fibrous materials such as carbon fiber, or other suitable materials and/or a combination of these materials where one material provides strengthening reinforcement to another material (e.g., fiber reinforced composite materials), to substantially enclose at least a portion of cockpit 22. It may be appreciated that these panels 25, 48, 54, 56 can be formed from lightweight materials which do not significantly increase the weight of vehicle 2 but provide protection from the elements for the passengers of vehicle 2.

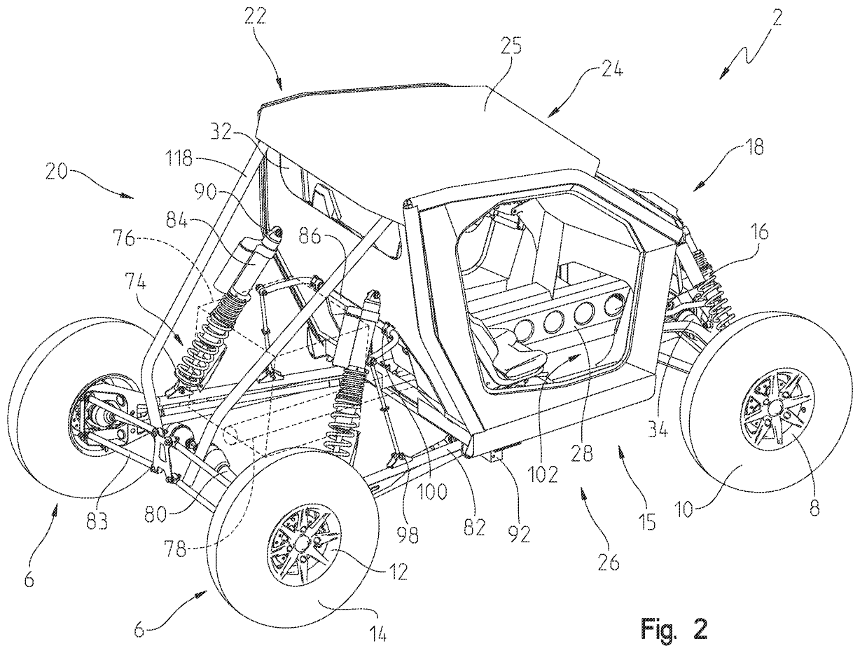

In addition to the panels noted herein, cockpit 22 can also include one or more windshields 30, which can be a split windshield design. Windshield(s) may be supported on front panel 52 such that front panel 52 may be used on vehicle 2 with or without windshield(s) 30. In some embodiments, windshield(s) 30 can be removed and stored inside cockpit 22, such as behind seating area 40. Cockpit 22 can also include rear windshield 32 (as illustrated in FIG. 2), which can be a power window. Although not illustrated, upper frame 24 can include a sunroof. Roof panel 25 can also include pockets and accessory attachments which can be machined into the material used to upper frame 24.

The configuration of cockpit 22 provide the passengers of vehicle 2 with protection from objects (e.g., tree branches) as well as the elements (e.g., rain, snow, dirt, etc.). Because cockpit 22 may be at least partially enclosed (e.g. sealed), vehicle 2 can also be fitted with a heating ventilation and air conditioning (HVAC) system to supply heating or cooling to the passengers of vehicle 2, as disclosed herein. Additionally, cockpit 22 can also be positively pressurized by the HVAC system and/or other systems of vehicle 2, where the positive pressurization additionally prevents liquid and/or dirt from entering cockpit 22. For example, in various embodiments, cockpit 22 may be pressurized through tunnel 136.

As noted herein and shown best in FIGS. 1-8, the enclosure of cockpit 22 (e.g., through roof panel 25, hood panel 48, front cockpit panel 52, side cockpit panels 54, and rear cockpit panel 56) and lower cockpit frame 26 can be integrally formed as a monocoque. In this case, frame assembly 15 and the enclosure of cockpit 22 can be integrally formed together from materials integrally bonded to one another to form the monocoque, either during or after the manufacturing process. For example, at least portions of frame assembly 15 and the enclosure panels of cockpit 22 can be cast from metal (e.g., aluminum) in the same processing step to integrally form cockpit 22. Alternatively, plastic may be molded, or carbon fiber could be laid, to integrally form both the frame and the enclosure of cockpit 22. Combinations of forming materials can be used to integrally form the monocoque (e.g., combinations of aluminum casting, plastic molding, and carbon fiber laying) resulting in a multi-material monocoque. The monocoque design of cockpit 22 can reduce the overall weight of vehicle 2 as well as increase the strength of vehicle 2 because the stress points of cockpit 22 are integrally bonded to one another rather than being connected by other means (e.g., gussets, etc.). In some embodiments, only a portion of cockpit 22 is a monocoque. For example, only lower cockpit frame 26 and the corresponding enclosure surrounding lower cockpit frame 26 are integrally formed as a monocoque and other portions of frame assembly 15, cockpit 22, and/or vehicle 2 are separately attached to the monocoque to form cockpit 22.

Cockpit 22 and/or portions of frame assembly 15 can also include features to lighten vehicle 2. For example, any frame members and/or enclosure panels can include holes to lighten the weight thereof. While such frame members and/or panels may be comprised of light-weight materials and/or are configured with such light-weighting features as holes, these frame members and/or enclosure panels are configured to support accessories (e.g., speakers, lights, handles, etc.). For example, accessories can be mounted to frame members and/or enclosure panels via the light-weighting holes. In some embodiments, holes can also be used to lighten lower cockpit frame 26 and/or seating frame 102.

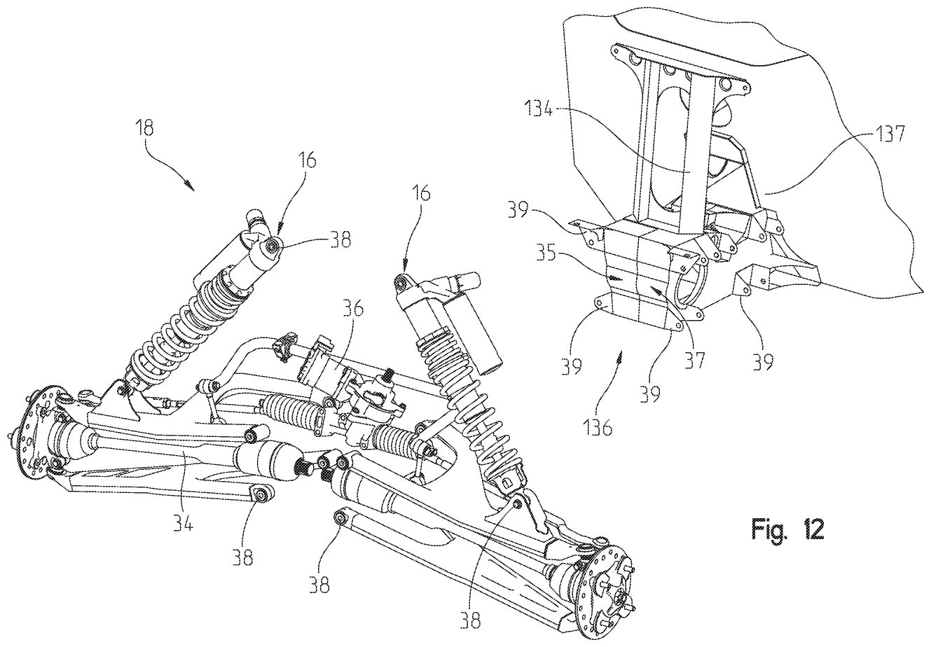

With additional reference to FIG. 12, frame assembly 15 includes front clip 18. Front clip 18 provides support for, and connects to, front drive assembly 34, steering assembly 36 (which may be a power steering assembly), and front suspension assembly 16. Front clip 18 includes a main body 137, a pair of forward upstanding front clip members 134 extending upwardly from the main body 137, and, in some embodiments, may include a portion of tunnel 28 (e.g., front tunnel component 136). Front clip 18 includes a plurality of mounting members 39 configured to support various systems and components of vehicle 2, such as front drive 34, front suspension 16, steering assembly 36, a radiator (not shown), etc.

Front clip 18 can be cast from various materials (e.g., metals, plastics, carbon fiber, etc.) with a variety of mounting points 38 on mounting members 39 formed in the cast, or attached to front clip 18 after casting. By including multiple mounting points 38 on mounting members 39 into the front clip 18, various designs of front drive structures 34, steering assembly 36, and/or front suspension assembly 16 can be attached to front clip 18. As such, the same front clip 18 can be adapted for different applications of vehicle 2. In some embodiments, front clip 18 is formed by casting the structure in two halves, and the two halves can be bolted together to form a two-part front clip 18. For example, front clip 18 can include first half 35, which may be the left half of front clip 18, and may also include second half 37, which may be the right half of front clip 18. The two halves can be bolted to one another creating a vertical seam and forming front clip 18. In other cases, front clip 18 can be cast as a single part. In other embodiments, front clip 18 can also be a tubular structure surrounded by sheeting or a formed structure. In either case, front clip 18 can comprise a single material (e.g., front clip 18 formed from the same composite material as other components of the frame) or could be comprised of a combination of materials (e.g., carbon fiber reinforced composite sheeting).

Front clip 18 is designed to isolate the front drive of vehicle 2. For example, front drive assembly 34 can be cross mounted, and steering assembly 36 can be used for structural support of front drive assembly 34. This design removes the need for casting additional support beams into front clip 18, therefore reducing the weight and cost of front clip 18. Front clip 18 can also include a radiator mount, and a radiator for vehicle 2 can be attached to front clip 18. Front clip 18 can also include a winch mount where a removable (or permanent) winch can be attached to front clip 18.

Front clip 18 is designed with clearances to accommodate an integrated steering rack assembly 36, which includes a power steering unit. Front clip 18 can be designed to minimize damage caused by a front impact to vehicle 2. For example, structural stiffening of the components of front clip 18 and cockpit 22, as well as the connections between cockpit 22 and front clip 18 and the materials selected to form front clip 18 and cockpit 22, can be designed to absorb energy by deformation and minimize the impact to the passengers of vehicle 2 during a front-end collision. As discussed above, cockpit 22 is configured to accommodate different embodiments of both front clip 18 and rear subframe 20 for different vehicle applications. As such, different designs of front clip 18 than illustrated can be used in vehicle 2.

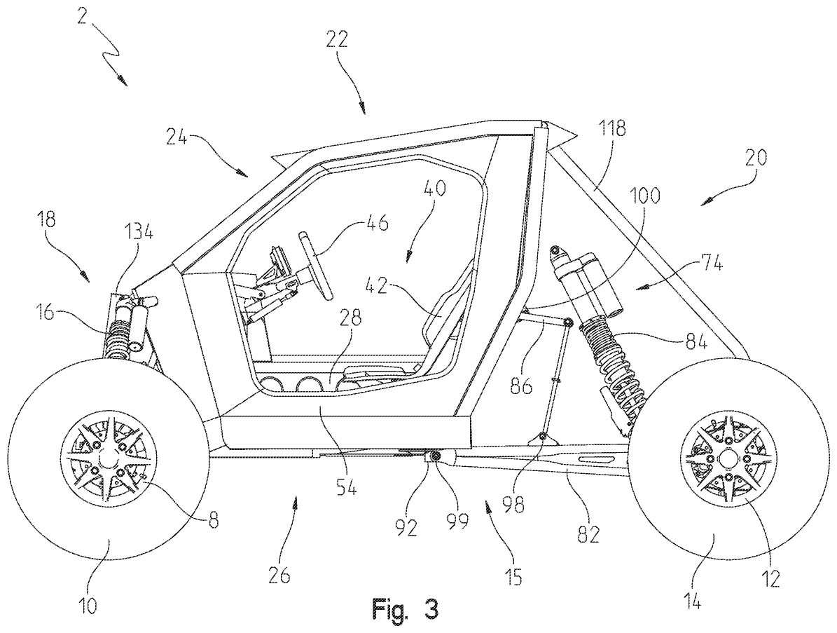

Vehicle 2 includes rear subframe 20, which is best illustrated in FIG. 2. Rear subframe 20 connects to, and provides support for, rear drive assembly 80, rear suspension assembly 74, and powertrain assembly comprising at least engine 76 of vehicle 2. Rear subframe 20 can be a complete rear subframe that can be mounted to cockpit 22 at various attachment points as discussed in detail herein. Rear suspension assembly 74 includes trailing arms 82, rear shock assemblies 84, upper and lower alignment or control arms 83, and torsion bar assembly 86. Torsion bar assembly 86 is operably coupled to trailing arms 82 (e.g., at couplings 98) and to rear subframe 20 (e.g., at couplings 100). The lower portions of rear shock assemblies 84 can be operably attached (e.g., bolted) to trailing arms 82 at couplings 88 and the upper portion of rear shock assemblies 84 can be operably attached (e.g., bolted) to rear subframe 20 at a second end (e.g., couplings 90). As best illustrated in FIG. 3, trailing arms 82 can be attached (bolted) to cross bar 92 (e.g., at couplings 94), where cross bar 92 is a horizontal frame member generally defining a portion of cockpit 22. For example, cross bar 92 may be part of lower cockpit frame 26 and, therefore, can be part of the monocoque defining cockpit 22.

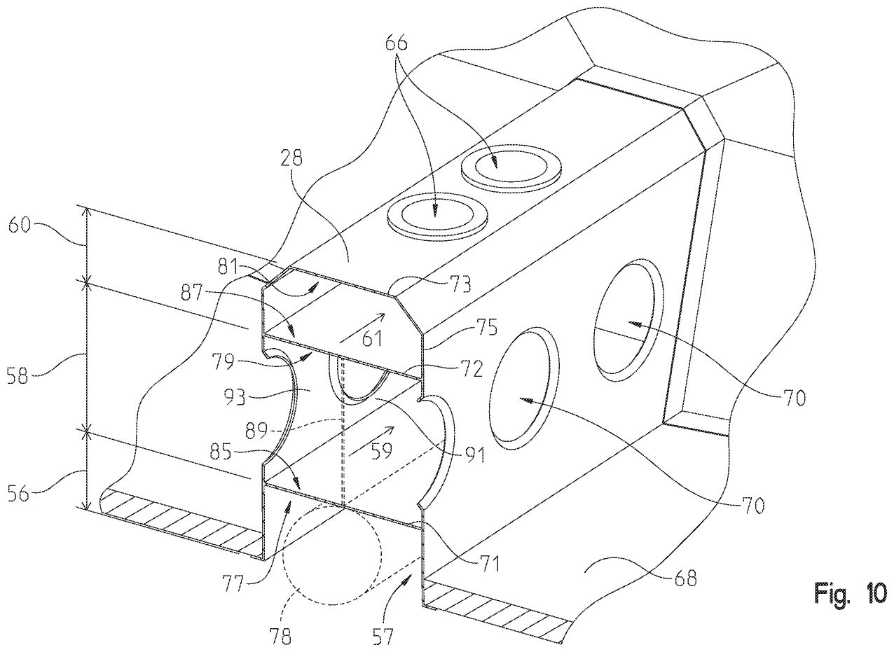

The powertrain assembly of vehicle 2 can include engine 76 which is supported by rear sub frame 20. In this way, portions of the powertrain assembly, for example at least engine 76, are positioned generally rearward of cockpit 22. While the powertrain assembly illustratively includes engine 76, the powertrain assembly may include any prime mover, such as an electric prime mover, a hybrid prime mover, etc. The driveline of vehicle 2 includes drive shaft 78 (FIG. 10) that connects front drive assembly 34 and rear drive assembly 80 with engine 76. Illustratively, a forward portion of drive shaft 78 extends longitudinally under or through cockpit 22 towards front drive assembly 34. A rearward portion of drive shaft 78 extends longitudinally under or through a portion of rear subframe 20 towards rear drive assembly 80. Rear subframe 20, cockpit 22, and front clip 18 can be designed to accommodate a variety of different prime movers (e.g., engine 76) and/or drive shafts 78 by the various attachment points and spacing of rear subframe 20 and front clip 18 to cockpit 22. As discussed above, cockpit 22 is designed with the flexibility to accommodate different forms of both front clip 18 and rear subframe 20 for different vehicle applications, depending on a variety of factors, such as the configuration and requirements of the powertrain assembly, the driveline, rear suspension assembly 74, front suspension assembly 16, and steering assembly 36, the engine 76, etc. For example, in some configurations (e.g., a top mounted configuration), cockpit 22 can accommodate mounting of the engine 76 to a portion of rear panel 56 and/or lower cockpit frame 26 to support engine 76.

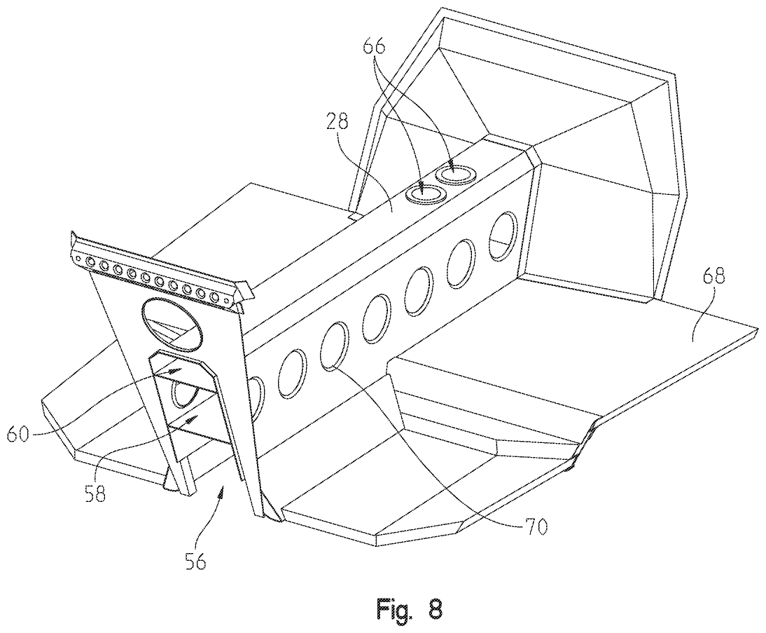

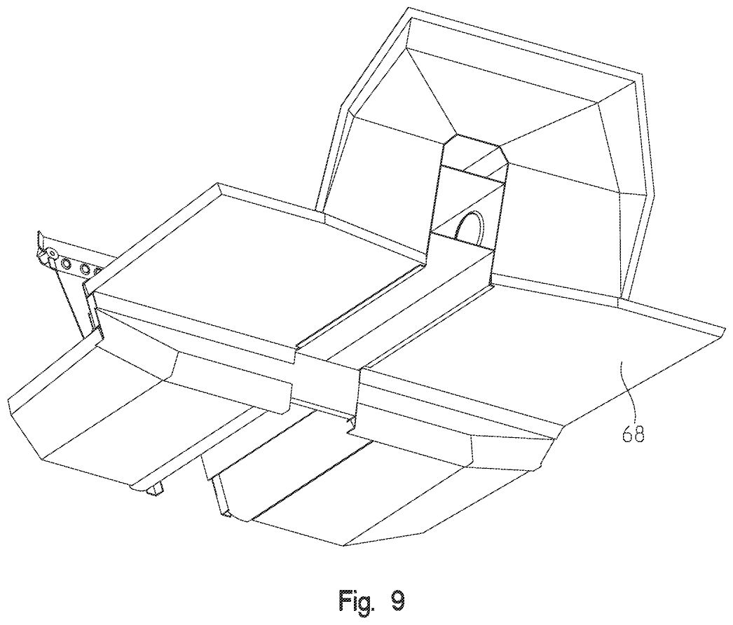

Referring to FIGS. 8-11, frame assembly 15 includes tunnel 28. In one embodiment, tunnel 28 defines a portion of front clip 18. However, in other embodiments, tunnel 28 can define a portion of cockpit 22. For example, in such embodiments, tunnel 28 can be a separate component from cockpit 22 where tunnel 28 is attached to cockpit 22 at various attachment points. Alternatively, tunnel 28 could be formed integrally with cockpit 22 (e.g., as in a monocoque design of cockpit 22), and as such, be part of cockpit 22. Tunnel 28 can be formed through stamping, extrusion, or other manufacturing methods and may be comprised of metallic materials (e.g., steel or aluminum), polymeric materials, and/or fibrous materials (e.g., carbon fiber). For example, tunnel 28 can include extruded materials bonded to stamped materials, bent materials bonded to fibrous materials, and any other combination of metal, plastic, or fibrous materials coupled or formed with one another.

Tunnel 28 includes a tunnel base 68 which can be formed of metallic, polymeric, and/or carbon fiber materials. Tunnel base 68 is configured to support and provide rigidity to at least a portion of cockpit 22. More particularly, tunnel base 68 can be designed to increase the strength of cockpit 22 at the attachment points of tunnel base 68 with front clip 18, rear subframe 20, and/or other portions of frame assembly 15 or cockpit 22. Tunnel base 68 can be formed as an integral unit with multiple vertical heights.

Additionally, and as best illustrated in FIG. 10, tunnel 28 can further include multiple layers, any of which may be integrally formed with or removably coupled to each other and/or tunnel base 68. For example, tunnel 28 can include three layers defined as drive shaft layer 56, wiring or conduit layer 58, and HVAC layer 60. Each of the layers of tunnel 28 can be separated by cross beams (e.g. cross beams 71, 72, and 73) that run the longitudinal length of tunnel 28 as well a cross beam (e.g., cross beam 89) that runs the vertical length of a portion of tunnel 28. The cross beams can both separate the different layers of tunnel 28 and provide structural support for both tunnel 28 and cockpit 22. For example, cross beam 71 can provide support for drive shaft layer 56 and wiring or conduit layer 58 as well as separate drive shaft layer 56 from wiring or conduit layer 58. Cross beam 72 can provide support for conduit layer 58 and HVAC layer 60 as well as separate wiring or conduit layer 58 and HVAC layer 60. Cross beam 73 can provide support for HVAC layer 60, and also be the top portion of tunnel 28.

Cross beam 89 can provide support for conduit layer 58 and HVAC layer 60, as well as vertically separate left half 93 from right half 91 of conduit layer 58. In this case, one half of conduit layer 58 may be used to support ducting conduits or other conduits for either the engine and/or the clutch (e.g., continuously variable transmission) of vehicle 2. The details of a continuously variable transmission and the corresponding ducting configured for vehicle 2 may be illustrated and discussed in U.S. patent application Ser. No. 16/861,859, filed Apr. 29, 2020, and entitled “VEHICLE” and U.S. Patent Application Publication No. 2019/0285160, filed Mar. 19, 2019, and entitled “CONTINUOUSLY VARIABLE TRANSMISSION,” the complete disclosures of which are expressly incorporated by reference herein. Although shown as part of conduit layer 58, the ducting could alternatively be routed through either drive shaft layer 56 or HVAC layer 60, or in other cases, through an additional (unillustrated) layer. In these examples, cross beam 89 can also be included in each of the layers where the clutch and/or engine ducting is routed to divide the layer in half.

Drive shaft layer 56 is the bottom layer of tunnel 28 and includes an open volume or space defining a longitudinal passage 57 where drive shaft 78 of vehicle 2 passes through cockpit 22 to connect front drive assembly 34 with engine 76. Drive shaft layer 56 may be coupled to or integrally formed with tunnel base 68 and, illustratively, includes upstanding walls 75 extending upwardly from tunnel base 68 and an upper surface 77 extending generally between the upstanding walls 75. In this way, drive shaft layer 56 defines the longitudinal passage 57 configured to receive at least the forward portion of drive shaft 78. The longitudinal passage can be sized for a variety of different diameters or geometries of drive shaft 78 that are used in vehicle 2.

Wiring or conduit layer 58 is positioned above drive shaft layer 56 and can include a longitudinal passage 59 that connects electrical, fluid, and/or pneumatic lines, wires, or other components between the front end of vehicle 2 and the rear end of vehicle 2. For example, wires and hoses can be routed therethrough to both hide and protect the wires and hoses from the passengers of vehicle 2 and dirt and debris. Illustratively, wiring or conduit layer 58 may be defined by the upper surface 85 of cross-beam 71 and a lower surface 79 of a second cross-beam 72. The two surfaces may be generally parallel to on another. In this way, wiring or conduit layer 58 defines an open volume or space 59 extending between these parallel surfaces which is configured to receive lines, wires, conduits, or other components of vehicle 2. Additionally, the upstanding walls 75 defining a portion of drive shaft layer 56 also may define a portion of wiring or conduit layer 58. As shown best in FIG. 10, the upstanding walls 75 may include openings 70 to reduce the weight of tunnel 28.

HVAC layer 60 can be formed above wiring layer 58 and can also form a longitudinal passage 61 (e.g., air duct) that connects the front portion of cockpit 22 with rear subframe 20 of vehicle 2. Illustratively, HVAC layer 60 may be positioned above wiring or conduit layer 58 and may define an open volume or space 61 therethrough. As shown best in FIG. 10, HVAC layer 60 is defined by the upper surface 87 of wiring or cross beam 72 and is generally enclosed by an the lower surface 81 of uppermost cross-beam 73 and upstanding walls 75. The uppermost surface 81 may include recesses 66 which are configured as cup holders for cockpit 22. In this way, tunnel 28 extends into cockpit 22 to accommodate drive shaft 78 but also provides functionality to the operator and passenger in cockpit 22. In one embodiment, tunnel 28 may be positioned between the seats in seating area 40 and, therefore, does not interfere with the seats or the ergonomic space available for the operator and passenger.

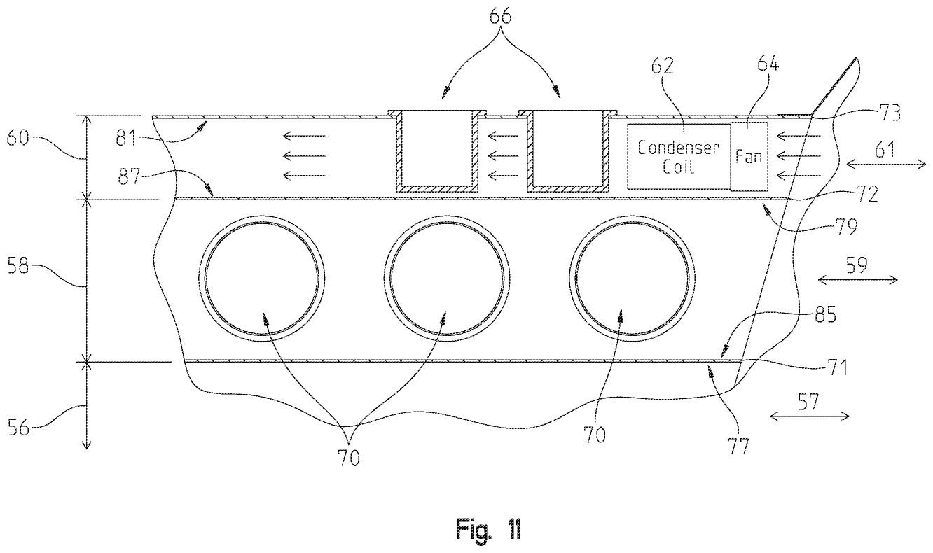

As illustrated in FIG. 11, HVAC components, such as condenser coil 63 and fan 64, can be position within the longitudinal passage of HVAC layer 60. Fan 64 and condenser 62 can operate in combination to circulate cooled air within cockpit 22 and can also cool beverages in cup holders 66. For example, fan 64 can be operated to force air (either fresh air from outside of cockpit 22 or from recirculation of air from inside cockpit 22) across the coils of condenser 62 and into contact with cup holder 66. Condenser 62 cools the air and provides cooled (e.g., air conditioned) air to either maintain a beverage in cup holder 66 at a precooled condition or cool down a warm beverage that is in cup holder 66. In this case, the cooled air comes in contact with the bottom surfaces of the cup holder that are recessed into the top surface of HVAC layer 60, and the cooled surfaces of cup holder 66 chills the beverage within cup holder 66. Although not illustrated, the HVAC layer can also include heating apparatuses rather than, or in addition to, condenser 62, where fan 64 can force warm air through the longitudinal passage of HVAC layer 60. This can also be used to warm beverages within cup holder 66. The cooled or warmed air can pass through tunnel 28 to one or more ventilation openings (not illustrated) that protrude from HVAC layer 60 and/or to vents within cockpit 22. The warmed or cooled air can provide cooling and/or heating to cockpit 22, which may be based on either electronic control of the temperature of vehicle 2 (e.g., via a thermostat) or on manual operation of the heating and/or cooling apparatuses by the occupant of vehicle 2.

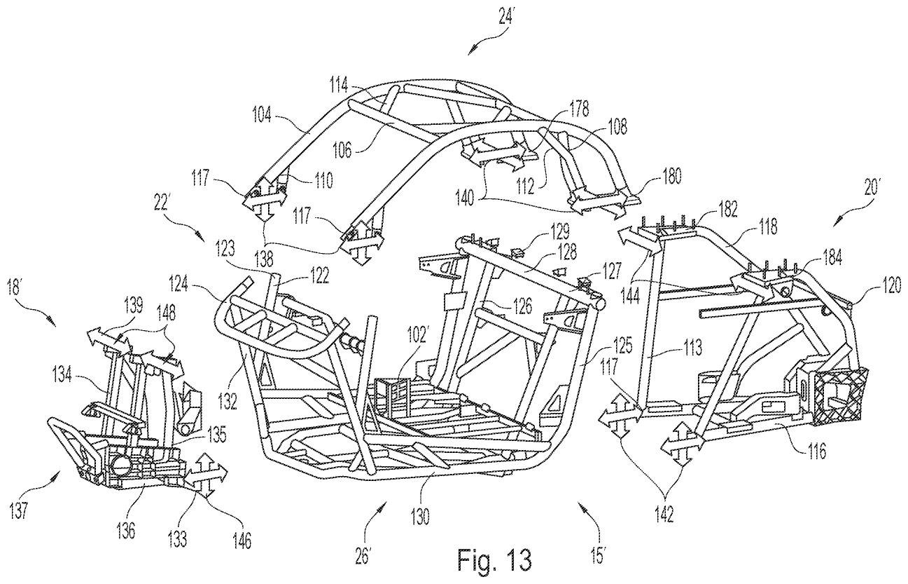

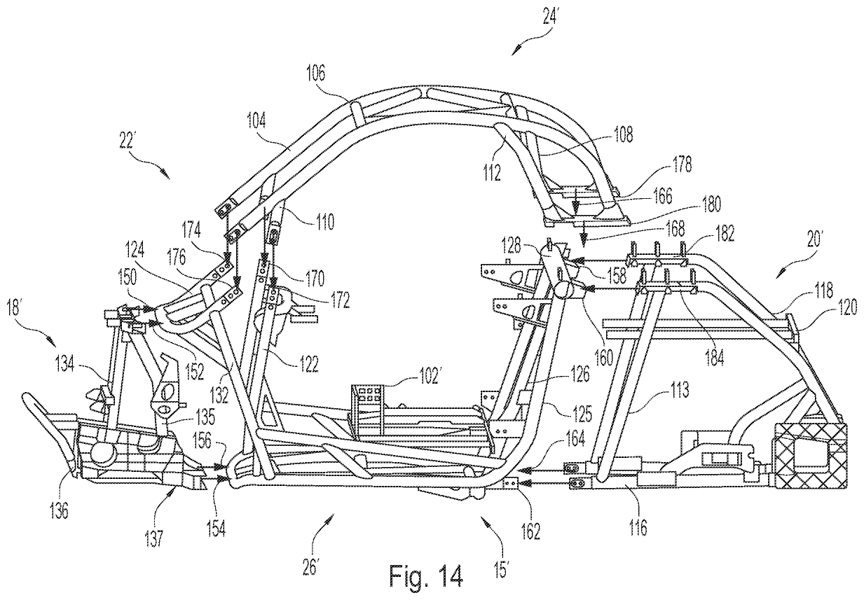

Referring now to FIGS. 13 and 14, an alternative embodiment of frame assembly 15 (FIGS. 1-8) is shown as frame assembly 15′. Depending on the application of vehicle 2 and/or other factors, either of frame assemblies 15, 15′ may be used with enclosure panels 25, 48, 52, 54, 56 (FIG. 1) to define cockpit 22. Additionally, enclosure panels 25, 48, 52, 54, 56 may be formed with portions of frame assembly 15′ to define cockpit 22 as a monocoque.

Frame assembly 15′ includes front clip 18′ which may be removably coupled to cockpit 22, as disclosed further herein. Front clip 18′ includes a main body 137, a pair of forward upstanding front clip members 134, a pair of rear upstanding front clip members 135, and front tunnel component 136. Main body 137 may be defined by two, generally symmetrical cast portions (e.g., first half 35 and second half 37) which are removably coupled to each other with mechanical fasteners, such as bolts. Tunnel component 136 may be integrated with main body or may be coupled thereto. A rear portion of main body and/or tunnel component 136 may include couplers 133 for coupling with portions of frame assembly 15′ defining cockpit 22. Upstanding clip members 134, 135 extend generally upwardly from main body and/or tunnel component 136. Upper portions of upstanding clip members 134, 135 may include couplers 139 for coupling with portions of frame assembly 15′ defining cockpit 22.

Frame assembly 15′ also includes rear subframe 20′ comprising multiple frame members. Illustratively, rear subframe 20′ includes a pair of upstanding rear subframe members 113, a pair of longitudinally-extending rear subframe members 116, a pair of rearwardly-extending members 118, and horizontal rear subframe member 120. Upstanding rear subframe members 113 are attached to both rearwardly-extending members 118 and lateral rear subframe members 116, and horizontal rear subframe member 120 is attached to rearwardly-extending members 118.

A forward portion of rearwardly-extending frame members 118 may include plates 182, 184. Plates 182, 184 may define coupling locations for connecting with a portion of frame assembly 15′ defining cockpit 22, as disclosed herein. Additionally, forward ends of longitudinally-extending members 116 may include couplers 117 for coupling with portions of frame assembly 15 defining cockpit 22.

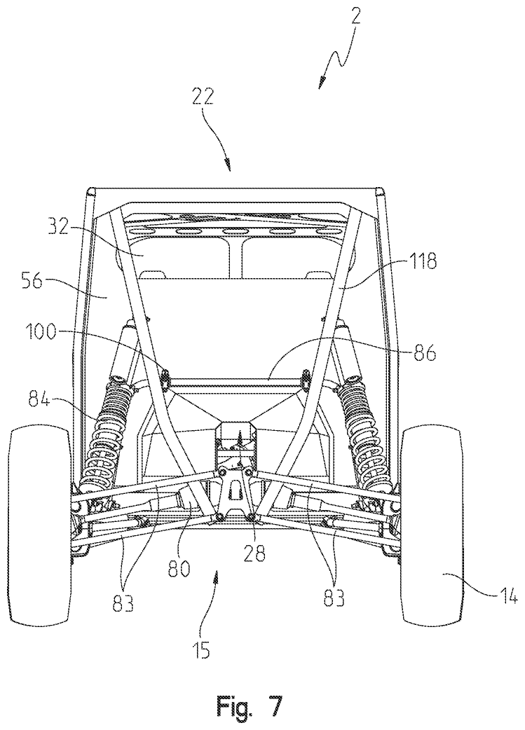

Referring still to FIGS. 13 and 14, frame assembly 15′ includes upper and lower portions coupled to each other to generally define a portion of cockpit 22. Illustratively, frame assembly 15′ includes upper or cab frame 24 and lower cockpit frame 26′ coupled together. Lower cockpit frame 26′ includes forward upstanding members 122 positioned longitudinally forward of seating frame 102′ and rearward upstanding members 125 positioned longitudinally rearward of sating frame 102′. Forward upstanding members 122 each includes a coupler 123 for coupling with a portion of upper frame and rearward upstanding members 125 each includes a coupler 127 for coupling with a portion of upper frame 24. Additionally, lower cockpit frame 26′ can also include connection joints or couplers 129 to attach to rear subframe 20′ and rear suspension assembly 74 (FIG. 7).

Additionally, lower cockpit frame 26 comprises a generally U-shaped cockpit frame member 124, a pair of frame members 132, a pair of inward upstanding rear cockpit frame members 126, horizontal rear cockpit frame member 128, and multiple longitudinal cockpit frame members 130. Both outward upstanding rear cockpit frame members 125 and inward upstanding rear cockpit frame members 126 are attached to horizontal rear cockpit frame member 128, and multiple longitudinal cockpit frame members 130 connect to both outward upstanding rear cockpit frame members 125 and inward upstanding rear cockpit frame members 126. U-shaped cockpit frame member 124 connects to U-support cockpit frame members 132.

Frame assembly 15′ also includes upper frame 24 comprising a pair of longitudinally-extending frame members 104, a pair of cross members 106, a pair of rear upstanding frame members 108, a pair of front upstanding roof frame members 110, a pair of lateral roof support members 112, and multiple diagonal roof support members 114. Longitudinally-extending frame members 104 are arranged in a longitudinal direction extending from the front of vehicle 2 to the rear of vehicle 2 where rearward upstanding frame members 108 and front upstanding frame members 110 extend from the bottom of longitudinally-extending frame members 104. Cross members 106 are coupled to longitudinally-extending members 104. Lateral support members 112 extend laterally from cross members 106. In one embodiment, upper frame 24 is a single component where the various frame members are integrally formed with each other during the forming process or define a single-piece weldment.

Various members of frame assembly 15′ define tubular frames which can be injected with materials such as foams, resins, or other suitable materials to provide additional strength, vibration and/or noise dampening, and/or thermal protection to frame assemble 15, 15′. For example, materials such as a honeycomb foam can be injected into frame assembly 15, 15′. Such materials can provide additional strength to various components of frame assembly 15, 15′ as well as absorb heat and/or noise and vibration created in vehicle 2. For example, the foam can also be injected into at least a portion of lower cockpit frame 26′ such as seating frame 102′ to increase the torsional strength thereof, isolate noise and/or vibration created by vehicle 2, as well as absorb heat given off by engine 76. Foam can also extend into the gaps between the frame members of upper frame 24 and/or lower cockpit frame 26 so that either, or both of, upper frame 24 and lower cockpit frame 26 are encased in structural foam. The addition of the foam to cockpit 22′ can also provide additional rigidity and protection for the passengers of vehicle 2 in the event of a front end collision. In some cases, tubing can be routed through the foam in upper frame 24, seating frame 102, and/or lower cockpit frame 26 and wires and/or pneumatic lines can be run within the tubing to hide and protect the wiring and/or tubing from damage.

With reference to FIG. 13, slip planes can be used when assembling lower cockpit frame 26, 26′, upper frame 24, 24′, front clip 18, 18′, and rear subframe 20, 20′ into vehicle 2. It may be appreciated that while the slip planes are shown with respect to frame assembly 15′ of FIG. 13, the frame assembly 15 of FIGS. 1-12 also may be assembled according to the follow disclosure.

The forward ends of longitudinally-extending members 104 and the lower ends of front upstanding frame members 110 create a pair of slip planes 138 when upper frame 24, 24′ is coupled to lower cockpit frame 26′. Slip planes 138 are two directional slip planes in both the vertical and lateral direction. During assembly, when longitudinally-extending members 104 and front upstanding frame members 110 are attached to U-shaped cockpit frame member 124 and the top of front upstanding cockpit frame members 122, one direction of movement of slip planes 138 is fixed. This allows for easy assembly and alignment of the components via fixing one degree of freedom of movement of slip planes 138 during installation. Similarly, slip planes 140, 142, and 146 are also two dimensional slip planes, where slip planes 140 is defined at the coupling of the rear ends of longitudinally-extending frame members 104 and the lower ends of lateral support members 112 to the forward portions of rearward members 118 of rear subframe 20, 20′ and the upper ends of upstanding rear members 113. Slip plane 142 is defined at the coupling of the forward portions of lateral rear subframe members 116 and the lower end of upstanding rear subframe members 113 to rearward portions of longitudinal cockpit frame members 130. Slip plane 146 is defined at the coupling of the rearward end of front tunnel component 136 to the forward portions of longitudinal cockpit frame members 130. When upper frame 24, 24′ and lower cockpit frame 26, 26′ of vehicle 2 are attached to each other at slip planes 138, 140, 142, 146, one degree of freedom is fixed to allow for easy assembly of vehicle 2.

Frame assembly 15, 15′ also includes slip planes 144 and 148, which are two dimensional slip planes in the horizontal direction, and during assembly of vehicle 2, one degree of motion is fixed to allow for easy assembly of vehicle 2. Slip plane 144 is defined at the coupling of the forward portion of rear subframe members 118 and the upper end of upstanding rear subframe members 113 to horizontal rear cockpit frame member 128. Slip plane 148 is defined at the coupling of the upper end of forward upstanding front clip members 134 and upstanding front clip members 135 to U-shaped cockpit frame member 124.

With reference to FIG. 14, multiple components of frame assembly 15′ (e.g., cockpit frame 26′, upper frame 24′, front clip 18′, and rear subframe 20′) can be attached to one another by pinning, bolting, welding, bonding, and/or keying (e.g., nesting, dovetailing, taper jointing) at various attachment points to form the structural support of vehicle 2. The attachment points can include materials that increase the overall strength of frame 15, 15′ by locally strengthening each attachment points (e.g., carbon fiber and/or composite reinforced attachment points). As discussed above, slip planes exist between lower cockpit frame 26, 26′, upper frame 24, 24′, front clip 18, 18′, and rear subframe 20, 20′. By utilizing attachment points located at the slip planes, the various modular components of vehicle 2 can be assembled to form a single unit. Additionally, the structural load points (e.g., the points where the stresses of vehicle 2 are focused) can be distributed by the attachment points. For example, front clip 18, 18′ is secured to cockpit 22 at attachment points 150, 152, 154, and 156. The upper portion of front clip 18,18′ (e.g., at the points where the top portions of forward upstanding front clip members 134 and rear upstanding front clip members 135 meet) is attached to U-shaped cockpit frame member 124 at attachment points 150 and 152. Attachment points 150 and 152 at least partially define slip planes 148 and couple (e.g., via bolts) the upper portion of front clip 18, 18′ to the forward portion of lower cockpit frame 26, 26′. The bottom of front clip 18, 18′ (e.g., at the rear of front tunnel component 136) is attached to the forward portions of longitudinal cockpit frame members 130 at attachment points 154 and 156. Attachment points 154 and 156 at least partially define slip planes 146 and couple (e.g., via bolts) the lower portion of front clip 18, 18′ to the forward portion of lower cockpit frame 26, 26′. By using attachment points 150, 152, 154, and 156, front clip 18, 18′ and lower cockpit frame 26, 26′ are secured to one another.

Rear subframe 20, 20′ is secured to cockpit 22 at attachment points 158, 160, 162, and 164. The upper ends of the forward portion of rear subframe 20, 20′ (e.g., at the points where the upper portions of upstanding rear subframe members 113 and the forward portions of rear subframe members 118 meet) is attached to horizontal rear cockpit frame member 128 at attachment points 158 and 160. Attachment points 158 and 160 at least partially define slip planes 144 and couple (via bolts) the upper portion of rear subframe 20 to the rear portion of bottom cockpit frame 26, 26′. The bottom forward portion of rear subframe 20, 20′ (e.g., at the points where the lower portions of upstanding rear subframe members 113 and the forward portions of lateral rear subframe members 116 meet) is attached to the rear portion of longitudinal cockpit frame members 130 at attachment points 162 and 164. Attachment points 162 and 164 at least partially define slip planes 142 and couple (e.g., via bolts) the lower portion of rear subframe 20, 20′ to the rear portion of lower cockpit frame 26, 26′. By using attachment points 158, 160, 162, and 164, rear subframe 20, 20′ and lower cockpit frame 26, 26′ are secured to one another.

Upper frame 24, 24′ is secured to lower cockpit frame 26, 26′ at attachment points 166, 168, 170, 172, 174, and 176 to form cockpit 22. The rear portion of upper frame 24, 24′ (e.g. at the points where the rear of longitudinally-extending frame members 104, the lower portions of lateral support members 112, and the lower portions of rear upstanding frame members 108 meet at plates 178 and 180) is attached to plates 182 and 184 (e.g. where the upper portions of upstanding rear subframe members 113 and the forward portions of rear subframe members 118 meet) at attachment points 166 and 168. Attachment points 166 and 168 at least partially define slip planes 140 and couple plates 178 and 180 to plates 182 and 184, thereby securing the rear portion of upper frame 24, 24′ to the upper rear portion of lower cockpit frame 26, 26′. Plates 182 and 184 can include upstanding bolts (e.g., male ends) and the plates 178 and 180 include holes (e.g., female ends) to receive the upstanding bolt of plates 182 and 184. Once the upstanding bolts of plates 182 and 184 are inserted into the holes of plates 178 and 180, nuts are used to secure the plates together.

The forward portion of upper frame 24, 24′ (e.g. at the front of longitudinally-extending frame members 104 and the lower ends of front upstanding frame members 110) is attached to U-shaped cockpit frame member 124 and the upper end of front upstanding cockpit frame members 122 at attachment points 170, 172, 174, and 176. Attachment points 170, 172, 174, 176 at least partially define slip planes 138 and couple (e.g., via bolts) the forward portion of upper frame 24, 24′ to the upper forward portion of bottom cockpit frame 26, 26′.

As discussed above, cockpit 22 can be a monocoque design (e.g., either lower cockpit subframe 26, 26′ and its corresponding enclosure panels and/or the combination of lower cockpit subframe 26, 26′ and upper frame 24, 24′ and the corresponding enclosure panels) and many different types of front clips 18, 18′ and rear subframes 20, 20; can be attached to cockpit 22 for different vehicle applications. Therefore, cockpit 22 can include additional and/or different attachment points for attachment of various front clips 18, 18′ and/or rear subframe 20, 20′.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A vehicle, comprising:
a frame;
front and rear ground engaging members supporting the frame;
a powertrain drivingly coupled to the front and rear ground engaging members; and
a seating area supported by the frame;
wherein the frame comprises a tunnel extending longitudinally through at least a portion of the seating area, and the tunnel supports one or more HVAC components.

2. The vehicle of claim 1, wherein the tunnel is formed as a single unit comprising a tunnel portion and a base portion.

3. The vehicle of claim 1, wherein the tunnel comprises a first layer, a second layer, and a third layer in a generally vertical arrangement.

4. The vehicle of claim 3, wherein the first layer defines a drive shaft layer configured to receive at least a portion of a drive shaft of the powertrain.

5. The vehicle of claim 3, wherein the second layer defines a conduit layer configured to receive at least one conduit extending in a generally longitudinal direction.

6. The vehicle of claim 3, wherein the third layer defines an HVAC layer configured to support the one or more HVAC components, and the third layer is positioned vertically above the first and second layers.

7. The vehicle of claim 6, wherein the one or more HVAC components include a fan and a condenser.

8. The vehicle of claim 7, wherein the third layer further comprises one or more cup holders positioned within an upper surface, and the condenser and the fan are operated to cool the one or more cup holders.

9. The vehicle of claim 7, wherein the seating area is at least partially surrounded by an enclosure and the fan and the condenser are operated to cool the seating area.

10. A casting for a vehicle, comprising:
a main body configured to support at least two of forward mounting members, steering mounts, suspension mounts, and front drive mounts.

11. The casting of claim 9, wherein the main body is comprised of at least a first portion and a second portion coupled to the first portion with removable fasteners.

12. The casting of claim 9, wherein the front drive mounts are positioned along an inner surface of the main body.

13. The casting of claim 11, wherein the suspension mounts are positioned along laterally outer surfaces of the main body.

14. The casting of claim 12, wherein the steering mounts are positioned longitudinally rearward of the suspension mounts.

15. The casting of claim 13, wherein the forward mounting members extend forwardly from the main body.
